(19) United States
(12) Patent Application Publication
(10) Pub. No.: US 2005/0195757 A1
(43) Pub. Date: Sep. 8, 2005

(54) Wireless association approach and arrangement therefor

(76) Inventors: Kenneth B. Kidder, Coon Rapids, MN (US); Conrad B. Beaulieu, Arden Hills, MN (US)

Correspondence Address: Honeywell International, Inc.;Patent Services Group, 101 Columbia Road, Morristown, NJ, 07962, US

(21) Appl. No.: 10/792,028

(22) Filed: Mar. 2, 2004

(51) Int. Cl. H04L 12/28

(52) U.S. Cl. 370/278; 370/351

(57) ABSTRACT

A system, apparatus, and method are directed to wireless association between a controller and a wireless node. In an example embodiment, a wireless node transmits association request data including unique identification (ID) data for the wireless node. A controller receives the association request data and, in response, assigns and sends association ID data to the wireless node using the unique ID with the association ID data to identify the wireless node as the intended recipient of the association ID data. The controller also stores the association ID data for use in sending wireless signals (e.g., messages) to the wireless node. The wireless node receives and stores the association ID data as a function of the unique ID, thereby associating the wireless node with the controller.

### FIELD OF THE INVENTION

This invention relates in general to wireless communications, and more particularly to a wireless communications approach involving the identification of wireless nodes and communication therewith.

### BACKGROUND OF THE INVENTION

Wireless communications have become an integral part of a variety of devices and systems for commercial, residential and personal use. Wireless telephones, Internet appliances and other devices are widely used in household and commercial environments. Wireless signals are passed between nodes in commercial systems for exchanging data, communicating control messages and other reasons. As these devices become more popular and their usage becomes more widespread, the potential for communication conflicts and errors increases. For example, where a plurality of wireless devices located in close proximity to one another use the same communications channels, it becomes difficult to properly deliver and manage wireless communications intended for a particular device. In addition, the large number of wireless signals (e.g., messages) potentially available to a particular wireless node makes it cumbersome and time consuming to parse all of the signals to determine whether any of the signals are intended for the particular wireless node.

One environment in which wireless communication devices are exposed to the potential of communication difficulties involves electronic controllers for energy-consuming equipment such as heating, ventilating and air conditioning (HVAC) type equipment. Electronic controllers such as thermostats and fan controls are used to control a variety of HVAC equipment as well as other fuel and energy consumption equipment. Furnaces, heat pumps, gas burners, water heaters, electric radiators, water radiators, air conditioners, chillers, fans, blowers and humidity controllers are example types of equipment for which electronic controllers are used. These controllers are often positioned in user-accessible locations, such as on an interior wall of a dwelling or commercial building. Typical controllers accept user inputs received via keypads or other input devices and use the inputs to generate control outputs that are sent to energy-consuming equipment. For example, HVAC controllers often include and/or are coupled to a temperature sensor and accept temperature set point inputs. In these applications, control messages are sent to HVAC equipment as a function of the set point inputs and an output from the temperature sensor. For instance, when a furnace system is in heating mode, a message calling for heat is sent to the furnace in response to sensing that a temperature is lower than a set point.

Residential and industrial HVAC type applications rely upon utility providers to supply the power (e.g., electrical power) and/or fuel required for operation of HVAC equipment. One challenge confronting such energy utility providers today is the great variance in total energy demand on an energy distribution network between peak and off-peak times during the day. Peak demand periods are intervals of very high demand on power generating equipment or on fuel supply where the reduction of energy consumption may be necessary to maintain proper service to the energy distribution network. These periods occur, for example, during hot summer days occasioned by the wide spread simultaneous usage of electrical air conditioning devices or during the coldest winter months in areas where a strong heating load is required.

Another characteristic of energy supply and usage that applies to both power and fuel is the variance in cost of the energy being supplied under different conditions. For instance, during peak demand times, the cost of providing the energy can increase due to a variety of conditions, such as the efficiency of power generation or fuel supply equipment, limitations in an energy distribution network, economical cost/demand relationships and energy network failures. In this regard, certain customers may be amenable to controlling their energy requirements as a function of cost, and certain utilities may preferably charge for services as a function of the time period at which usage occurs.

Several basic strategies and devices have been utilized for controlling HVAC equipment in order to limit the peak demand on the power and fuel generating capacity of utility companies. One such approach involves sending messages either over power lines or by utilizing a telephony message emanating from the utility to disconnect, schedule or interrupt the use of selected HVAC loads (e.g., air conditioning compressors or heating burners/elements) when the demand has reached a certain point. Another approach involves assuming control of the setpoint function of a thermostat associated with the HVAC equipment. The override control of the thermostat causes the setpoint to change to use less power or fuel at times of high demand or high unit cost.

Such approaches can be implemented for reducing power or fuel consumption during peak demand times or other times when the reduction in utility usage is desirable, such as during periods when the power and/or fuel cost per unit is high. However, typical implementations of these approaches involve the installation of control equipment for the HVAC equipment. This installation often requires the use of a skilled technician to physically install the control equipment at its location (e.g., within furnace housings), requiring that the technician have access to customer premises. In addition, typically installations of this type often require a significant amount of technician time, which can be expensive.

In addition, where multiple HVAC-type wireless communications nodes are located in close proximity to one another, the potential for communications difficulties related to multiple wireless messages and the identification thereof is significant. For instance, in some environments, multiple thermostats are used to control one or more environmental zones fed by one or more HVAC type systems. In other environments, different HVAC systems are located in close proximity, such as in a residential neighborhood where it may be desirable to use wireless communications for different HVAC systems in adjacent homes.

Accordingly, the above-discussed issues have been challenging to the implementation of a variety of devices and systems involving wireless communications, such as wireless climate control involving the control of HVAC and other types of equipment.

### SUMMARY OF THE INVENTION

To overcome limitations and issues described above, and to overcome other limitations that will become apparent upon reading and understanding the present specification, the present invention discloses a system, apparatus and method for addressing challenges related to wireless communication.

In one example embodiment of the present invention, a wireless association approach involves the use of an association ID assigned at two nodes to identify communications between the two nodes. A first node transmits association request data including a unique identification and a second node responds to the transmission by creating, storing and transmitting the association ID. The second node labels the association ID transmission with the unique ID for the first node. The first node parses the association ID transmission and stores the association ID as a function of its unique ID.

In accordance with another embodiment of the invention, a wireless association is created between a controller and a wireless node. The wireless node transmits association request data including unique identification (ID) data for the wireless node. The controller receives the association request data and, in response, assigns association ID data to the wireless node and stores the association ID data for use in sending wireless signals to the wireless node. The assigned association ID data is also sent to the wireless node using the unique ID to identify the wireless node as the intended recipient of the association ID data. The wireless node receives and stores the association ID data using the unique ID to identify the association ID data as intended for the wireless node. The association ID data, now stored at both the wireless node and the controller, can be used in further communications between the wireless node and the controller, thereby associating the wireless node with the controller.

### BRIEF DESCRIPTION OF THE DRAWINGS

Various example embodiments of the invention are described in connection with the embodiments illustrated in the following diagrams.

FIG. 1 is a wireless system configured and arranged for establishing an association between selected nodes therein, according to an example embodiment of the present invention;

FIG. 2 is a flow diagram showing a method for associating selected nodes in a multiple node environment, according to another example embodiment of the present invention;

FIG. 3 is a block diagram of a wireless system including a thermostat body and subbase, controller and at least one other wireless device, according to another example embodiment of the present invention;

FIG. 4 is a block diagram of a RF (radio frequency) device, according to another example embodiment of the present invention;

FIG. 5 is a block diagram of a RF peripheral, according to another example embodiment of the present invention;

FIG. 6 is an energy control system including a local gateway and a plurality of wireless thermostats, according to another example embodiment of the present invention;

FIG. 7 is a flow diagram showing a method for communicating messages from a controller to a thermostat in an environment with multiple controllers and multiple thermostats, according to another example embodiment of the present invention;

FIG. 8 is a flow diagram showing a method for communicating from a thermostat to a controller in an environment with multiple controllers and multiple thermostats, according to another example embodiment of the present invention; and

FIG. 9 is a flow diagram showing a method for conflict checking with an association approach between a wireless node and a controller in an environment with multiple controllers and multiple wireless nodes, according to another example embodiment of the present invention.

### DETAILED DESCRIPTION OF THE INVENTION

In the following description, reference is made to the accompanying drawings that form a part hereof, and in which is shown by way of illustration particular embodiments in which the invention may be practiced. It is to be understood that other embodiments may be utilized, as structural and operational changes may be made without departing from the scope of the present invention.

According to an example embodiment of the present invention, a controller associates with wireless nodes and uses the association to send and/or receive wireless communications to and/or from selected wireless nodes. For each wireless node, the association involves the communication of a unique identification (ID) from the wireless node to the controller that, in response, assigns an ID to the wireless node. The assigned ID is communicated to the wireless node using the unique ID to ensure that the proper wireless node receives the assigned ID during the association. The wireless node then stores the assigned ID and includes it with outbound communications intended for the controller. In addition, the controller also includes the assigned ID with outbound communications intended for the wireless node, which uses the stored assigned ID to identify inbound communications sent by the controller. With this approach, the controller and the wireless node can communicate in an environment susceptible to a variety of wireless communications over the same wireless medium (e.g., the same communications channel) while ensuring that communications reach their intended recipient.

In a more particular embodiment, the controller and wireless nodes discussed above are part of a larger community of controllers and nodes communicating wirelessly over the same wireless channel or channels. Each controller has a unique ID for a particular network of nodes within the community, as well as controller identification for itself (here, a master ID). Association between each wireless node and a particular controller is effected in a manner similar to that discussed above. Each wireless node is assigned an ID that is based upon the ID of the network of nodes to which the wireless node belongs, a master ID and a slave ID assigned by the controller. The combination of network ID, master ID and slave ID is unique for each wireless node. In addition, each network ID is unique for a particular network of wireless nodes, with each controller being adapted to communicate with at least one network.

In one implementation, the controllers in the community are adapted to identify incoming communications as a function of a data range of one or more of the IDs associated with the incoming communications. For instance, a particular controller may be assigned to a plurality of networks having a network ID within a numerical range of IDs that is unique to the controller. In this regard, the controller can parse an incoming communication to determine whether the network ID associated with the incoming communication's ID is within the range of network IDs to which it is assigned. If not within range, the controller ignores the communication without having to further parse the communication. If within range, the controller processes the incoming communication. With this approach, the controller need not necessarily store all network IDs for wireless nodes to which it is assigned in order to identify incoming communications that should be processed.

The controller can also be assigned to a particular range of slave IDs within a network ID for which it executes control, the range of slave IDs being used for identification in a manner similar to that discussed above. Incoming communications are parsed to determine whether the slave ID associated with the incoming communication's ID is within the range of slave IDs to which the controller is assigned. If not within range, the controller ignores the communication without having to further parse information from the communication. If within range, the controller processes the incoming communication.

The above-discussed association approaches are applicable to a variety of control implementations. For example, HVAC type equipment and other energy-consuming equipment are often regulated with a thermostat or other similar type of controller. These controllers are typically wired to the equipment and accept user inputs, such as temperature settings for heating and cooling. Some advanced controllers also accept time-of-day related inputs so that temperature settings are automatically adjusted to reduce energy consumption during periods when heating or cooling is not needed or when a lesser amount is needed. For general information regarding control applications and for specific information regarding equipment control applications including HVAC applications that may be used in connection with one or more example embodiments discussed herein, reference may be made to U.S. patent application Ser. No. ______ (HONY.010PA), entitled “Wireless Controller with Gateway” filed concurrently herewith and fully incorporated herein by reference.

In many applications, it is desirable to allow utility companies who supply fuel and/or power to control HVAC type equipment for commercial and/or residential consumers that the utility company serves. The utility company can monitor demand and, in times of high demand, reduce the energy consumption of customers who have chosen to participate in energy-saving events.

In another example embodiment of the present invention, the association approach discussed herein is used to associate a utility controller with a plurality of wireless thermostats and/or other controllers in an environment for effecting energy-reduction control of HVAC and other types of equipment. Each of the wireless thermostats is associated with a particular utility controller, with communications therebetween using the association to ensure that the proper controller or thermostat receives wireless signals intended for it. The environment may, for example, include wireless thermostats for a plurality of homes and/or commercial enterprises in a neighborhood, with the utility controller being located in the neighborhood and adapted to selectively control each wireless thermostat. In addition, each home or commercial enterprise optionally includes more than one wireless thermostat, with the utility controller being adapted to selectively control each wireless thermostat. In some applications, a single utility controller is arranged to communicate with a network including a single home or commercial enterprise having a plurality of wireless thermostats. In other applications, a single utility controller is adapted to control two or more networks of wireless thermostats (e.g., with each home or commercial enterprise being a single network, or with a certain portion of the neighborhood making up a single network). With these approaches, wireless communications for effecting energy-consumption control can be effected in a close neighborhood environment while ensuring proper association of wireless channels used for sending control messages and for reporting operational data.

In the various example embodiments and implementations thereof discussed in connection with the figures and otherwise as follows, certain terms and reference numbers may optionally be implemented in a manner not inconsistent with other approaches discussed herein and involving similar terms and reference numbers. In this regard, certain discussion has been omitted for brevity. For instance, where association approaches are discussed, reference is made to various identification approaches and values. Certain values are referenced simply as an assigned ID; however, these simple references may be implemented using the ID values and approaches discussed above and elsewhere in this document. In addition, various terminology used in connection with the transfer of wireless information can be implemented using one or more approaches. In this regard, terminology such as “wireless signals” and “wireless messages” may include signals (or a series of signals that make up a message), structured messages and any other wireless signals capable of over-the-air (OTA) transmission.

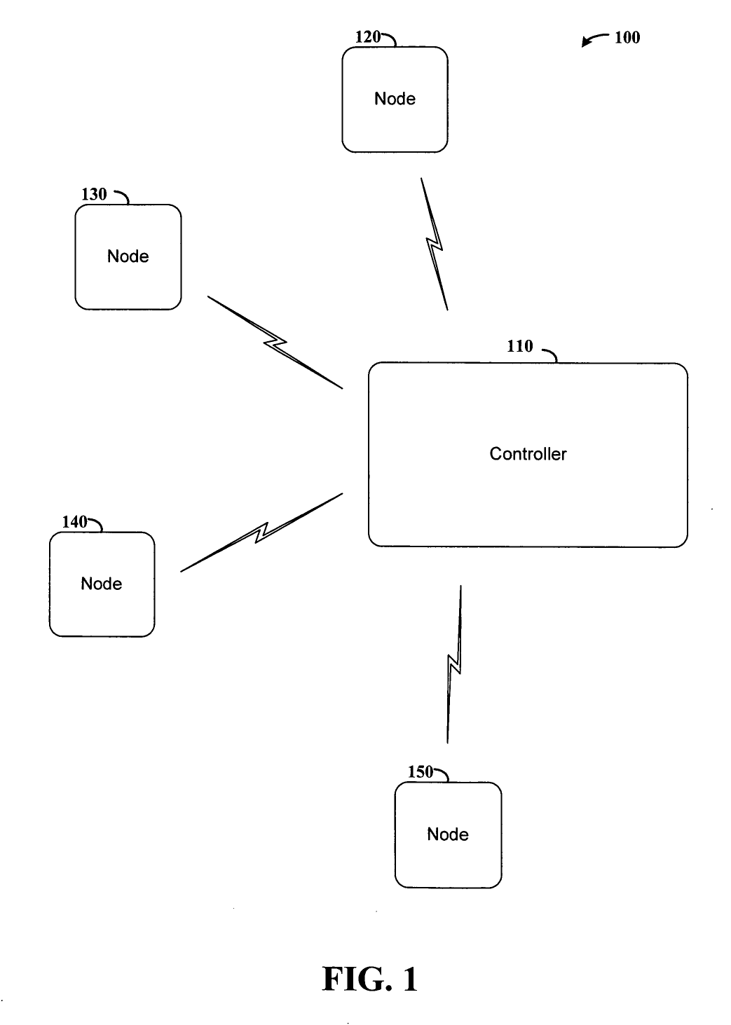

FIG. 1 shows a wireless system 100 that uses an association method for establishing wireless communications between selected nodes in the system, according to another example embodiment of the present invention. A controller 110 communicates with wireless nodes 120, 130, 140 and 150 for establishing an association therebetween. Once an association is established, each of the wireless nodes 120-150 uses the association to identify communications sent to the controller 110 to both ensure that the proper controller receives the communications and identify to the controller which wireless node sent the communication. In addition, the controller 110 uses the association to identify which wireless node is the intended recipient for a particular wireless message (e.g., wireless signals).

Referring to wireless node 120 as an example, an association request is initiated at the wireless node in response to user input (e.g., a user executing an association request input) or an automatic association request (e.g., upon power-up of the wireless node). The wireless node 120 then enters an association mode, sends a wireless association request message that includes a unique ID for the wireless node 120, and waits for a response to the association request message. The controller 110 also enters an association mode either manually in response to user input or automatically in response to detecting the association request message from the wireless node 120. In response to receiving the association request message, the controller 110 uses the unique ID to send a response to the wireless node 120 that includes an association ID assigned by the controller 110. The association ID is stored at both the wireless node 120 and the controller 110 and is used for future communications between the wireless node and the controller.

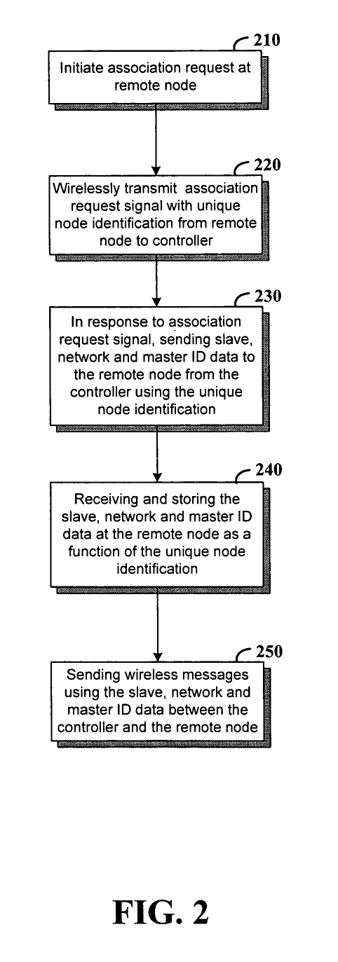

FIG. 2 is a flow diagram showing a method for associating selected nodes in a multiple node environment, according to another example embodiment of the present invention. The association approach shown in FIG. 2 may be applicable, for example, to the wireless system 100 shown in FIG. 1 and discussed above. At block 210, an association request is initiated at a remote node. An association request message is wirelessly transmitted from the remote node to a controller at block 220 and includes a unique ID for the remote node. At block 230, in response to the association request message, the controller sends association ID data including slave, network and master ID data to the remote node using the unique ID to inform the remote node that it is the intended recipient of the association ID data. At block 240, the slave, network and master ID data is received and stored at the remote node and the remote node verifies the data with the unique ID. Association between the remote node and the controller is thus established and wireless messages are then sent therebetween at block 250 using the slave, network and master ID data.

The slave ID data is selected by the controller and is unique for each remote node to which it is assigned. For instance, when a plurality of remote nodes are identified with slave IDs, slave ID data can be selected in succession, such that the nodes in the environment are assigned slave IDs in an identifiable range, with a next available ID being used for subsequent assignments. Stored slave ID data accessible by the controller can be used to ensure that additional assigned slave IDs are unique.

The network ID data is assigned by the controller for a particular logical network of remote nodes to be controlled by the controller (e.g., as discussed above, the network might be a neighborhood or a single location having multiple remote nodes). When multiple networks are assigned to a particular controller, as with the slave ID, the network IDs used may be selected in succession, such that newly-formed networks are given a network ID that is next in line for a range of network IDs assigned to the controller.

In one implementation, the master ID is selected by the controller and is unique for the controller. When used in an environment involving multiple controllers, the master ID is selected as a function of available IDs among the multiple controllers, such that no two controllers within wireless transmission range share the same master ID. With this approach, for example relative to an approach where the master ID is a factory-assigned ID, controllers can be replaced by programming a replacement controller with the same master ID (rather than relying upon a factory-assigned ID).

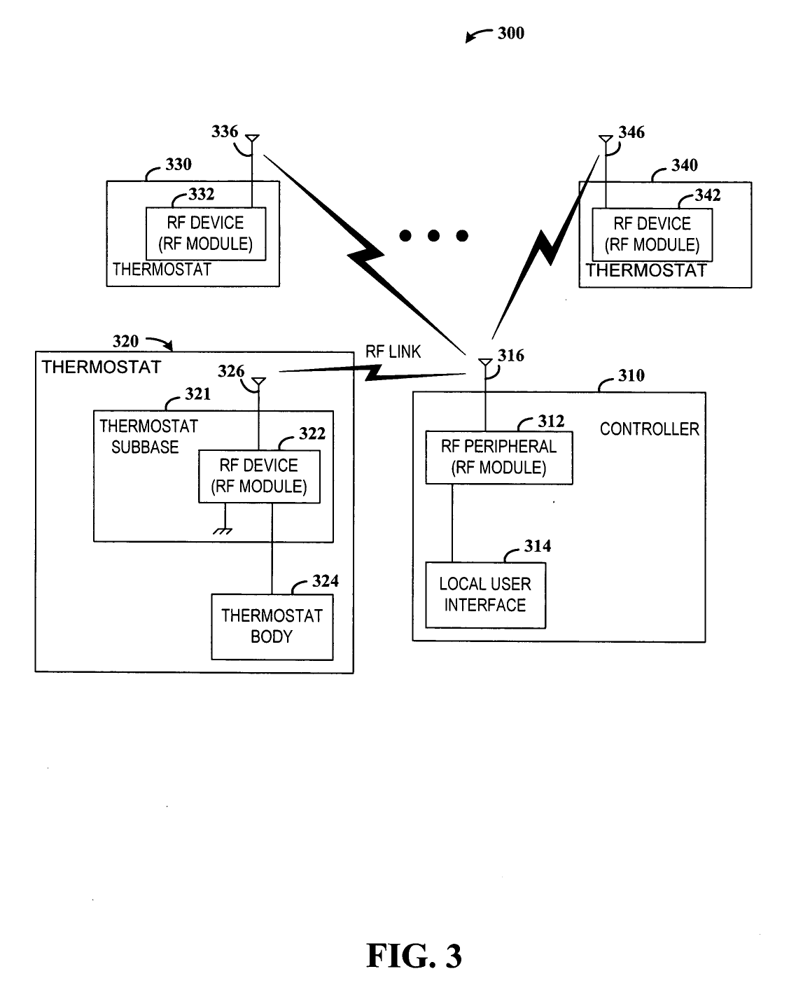

FIG. 3 is a block diagram showing a wireless system 300 including a controller 310 and a plurality of wireless thermostats 320, 330 and 340, according to another example embodiment of the present invention. The controller 310 includes an RF peripheral 312 and a local user interface 314. The RF peripheral 312 includes an antenna 316 adapted to send and receive RF signals with the wireless thermostats 320, 330 and 340. Each of the wireless thermostats 320-340 includes an RF module (respectively 322, 332 and 342), and each RF module has an antenna (respectively 326, 336 and 346) for sending and receiving RF signals. Association between the wireless thermostats and the controller 310 is executed using, for example, one or more of the approaches discussed above, with each wireless thermostat storing ID data assigned by the controller 310 and using the stored ID data to verify incoming messages. The controller 310 also uses the assigned ID data to identify wireless messages as coming from a wireless thermostat associated therewith.

The wireless thermostats 320-340 (and others, if present, as represented by the ellipses) may include one or more of a variety of types of devices and controllers. Referring to wireless thermostat 320 as an example, a thermostat subbase 321 includes the RF device 322 and the antenna 326. The subbase 321 couples to a thermostat body 324 that includes typical thermostat circuitry, such as a temperature sensor and a user input device for receiving temperature set points and other inputs. The wireless thermostat 320 is further configured to control an HVAC system as a function of thermostat control settings at the thermostat body 324 and inputs received via the antenna 326. The thermostat 320 processes information received via the RF device 322 as a function of the assigned ID data, with messages not including the ID assigned to the thermostat 320 being ignored.

In one implementation, the RF device 322 parses messages received via the antenna 326 to evaluate the messages for the assigned ID data. Messages are passed to the thermostat body 324 only if the assigned ID data is present in the messages. Association between the wireless thermostat and the controller 310 is thus carried out with the RF device 322 directly. For instance, an association request initiated at the wireless thermostat 320 involves the RF device 322 communicating its unique ID to the controller 310. The unique ID is received at the controller 310 and, in response, used to send an assigned ID to the wireless thermostat 320. The assigned ID is received at the antenna 326 and stored for use by the RF device 322 in parsing future wireless messages; those messages including the assigned ID are passed to the thermostat body 324.

In another implementation, the thermostat body 324 parses messages received via the antenna 326 to evaluate the messages for the assigned ID data. In this instance, the RF device 322 acts primarily as a passive information relay to present wireless messages to the thermostat body 324 without necessarily evaluating or otherwise participating in the communication. Association between the wireless thermostat 320 and the controller 310 involves sending a unique ID for the thermostat body 324 to the controller. The controller 310 responds by sending an assigned ID back to the wireless thermostat 320 using the unique ID to identify the wireless thermostat 320 as the intended recipient of the assigned ID. The assigned ID is then stored for use by the thermostat body 324 for parsing future messages to determine whether the messages belong to the wireless thermostat 320. In addition, the thermostat body 324 includes the assigned ID with messages sent from the wireless thermostat 320 to the controller 310 for identifying the messages as emanating from the wireless thermostat.

The local user interface 314 of the controller 310 can be used for a variety of purposes and may include one or more of a variety of interfaces. Manual selections can be input via the local user interface 314, for example, to initiate an association mode for associating a wireless thermostat with the controller or to program the controller. For instance, when installing a wireless thermostat onto a network covered by the controller 310, an installation technician can use the local user interface 314 to initiate an association mode. When a wireless thermostat within range of the controller 310 is also in an association mode, association messages received from the wireless thermostat are used to send an assigned ID from the controller to the wireless thermostat. The local user interface 314 can be used to control this association, for example, by accepting or rejecting association requests by particular wireless thermostats. In addition, other operational characteristics such as logical network establishment and assignment, communication protocols, data storage, wireless device deletion from a network or association and others are readily managed with the local user interface 314.

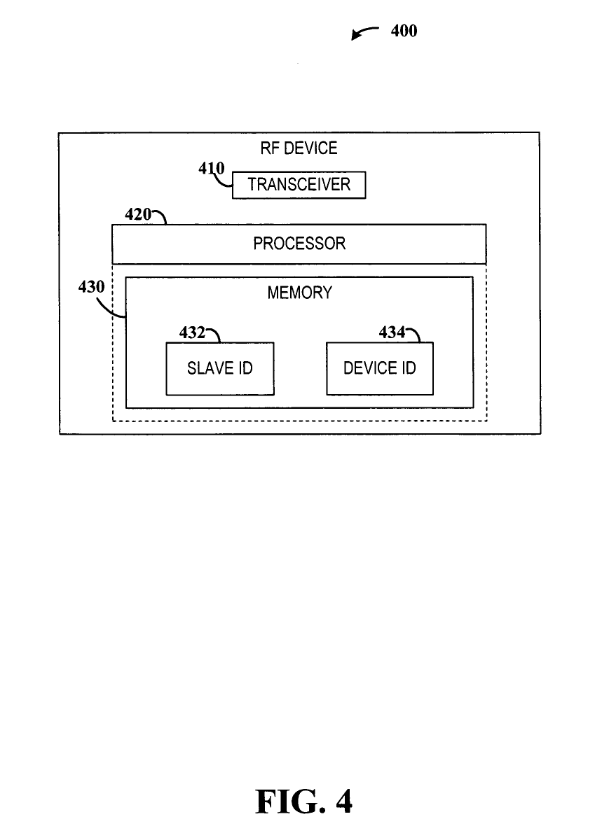

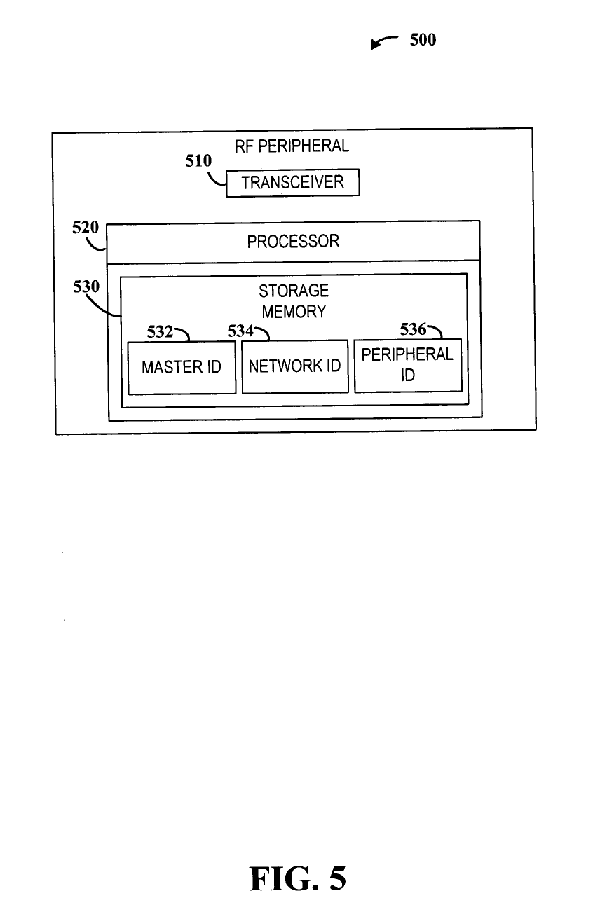

FIG. 4 is a block diagram of an RF device 400, according to another example embodiment of the present invention. The RF device 400 may, for example, be implemented with a device such as the RF devices 322, 332 and 342 shown and discussed in connection with FIG. 3 above. The RF device 400 includes a RF transceiver 410 that sends and receives RF signals, a processor 420 and memory 430 (e.g., a non-volatile memory). The processor 420 processes messages received at the RF transceiver 410 and prepares messages for sending with the RF transceiver, using the memory 430 to store ID data. Specifically, a unique device ID 434 (e.g., assigned during the manufacture of the RF device 400) stored in the memory 430 is used to establish an association between the RF device 400 and an RF peripheral, for example as discussed in connection with FIG. 5 below. Using the device ID 434, slave ID data is received from an RF peripheral using the RF transceiver 410 and stored as a slave ID 432. The processor 420 includes the stored slave ID 432 with subsequent communications intended for the RF peripheral from which the slave ID 432 was received. In addition, the processor further uses the slave ID 432 when parsing wireless messages received at the RF transceiver 410; only messages bearing the slave ID 432 are processed.

In one implementation, the slave ID assignment approach discussed above in connection with FIG. 4 is used for maintaining continuity during upgrades or equipment replacement in a system using the RF device 400. For instance, if the RF device 400 is serving a particular node, such as a node controlling a particular HVAC system, the slave ID assigned to the RF device is preserved by assigning the same slave ID to a replacement device during association thereof. The replacement may also involve a disassociation or unbinding type of process, wherein the RF device 400 sends a message to a controller, such as the RF peripheral discussed below in connection with FIG. 5. In response, the controller can prepare for association with the replacement device, for example by storing the slave ID 432 and other data to be downloaded to the replacement device. With these approaches, the unique device ID 434 is not necessarily relied upon for communicating information after association has been established. Referring to FIG. 3 and using this approach, the RF device 322 can be replaced upon failure or during an upgrade with a new RF device, such as the RF device 400, while maintaining the assigned ID with the RF device.

FIG. 5 is a block diagram of an RF peripheral 500, according to another example embodiment of the present invention. As mentioned above in connection with FIG. 4, the RF peripheral 500 may be used with the RF device 400. In addition, the RF peripheral 500 may be used in connection with the RF peripheral 312 in the controller 310 of FIG. 3. In some instances, the RF device 400 and RF peripheral 500 perform authentication functions such as address recognition (message filtering), conflict resolution, association, replacement, persistent storage and host interfacing.

The RF peripheral 500 includes an RF transceiver 510, a processor 520 and memory 530. The RF transceiver 510 is adapted for sending and receiving wireless messages with a plurality of RF devices. The processor 520 processes messages that are received at the RF transceiver 510 and prepares messages for wireless transmission to RF devices via the RF transceiver by using IDs stored in the memory 530 to identify the RF device intended as the recipient. The stored IDs include a master ID 532, at least one network ID 534 and one peripheral ID 536 that is unique to the RF peripheral 500 (i.e., assigned during the manufacture thereof). The master ID 532 is selected by the RF peripheral 500 and used for identifying itself in communications with RF devices, such as RF device 400 in FIG. 4. With this approach, the RF peripheral 500 can be replaced with a different RF peripheral, for example to upgrade or replace a defective device, in a manner similar to that discussed above in connection with continuity upon replacement in FIG. 4. The replacement RF peripheral stores the same master ID 532 and thus appears to be the same RF peripheral as viewed by RF devices associated with the replaced RF peripheral.

The network ID 534 is selected by the RF peripheral 500 to identify a logical network, with additional networks IDs being optionally used to define additional logical networks served by the RF peripheral. For example, referring to FIG. 3 wherein the RF peripheral 500 is implemented with the RF peripheral 312, one or more of the wireless thermostats 320, 330 and 340 can be grouped into a particular network having the network ID 534. This network ID is sent to the wireless thermostats (or other RF devices) and used for identifying future communications to the RF peripheral 312.

The RF peripheral 500 associates with an RF device by assigning an ID to the RF device, the assigned ID including the master ID 532, network ID 534 and a slave ID selected by the RF peripheral 500. The slave ID 434 in FIG. 4 is optionally stored in the memory 530 and used to identify incoming messages received at the RF transceiver 510. In one implementation, one or both of the network ID 534 and the slave ID information stored in memory 530 is stored in the form of a range. For example, by storing upper and lower bounds within a data range for these IDs, incoming messages including IDs within that range are accepted. The accepted messages can then be passed, for example, to a processor or other end-user (e.g., a utility company using the messages for energy control). With this approach, each network ID and slave ID used with the RF peripheral 500 need not be stored in the memory 530, thus reducing the amount of memory required for ID storage.

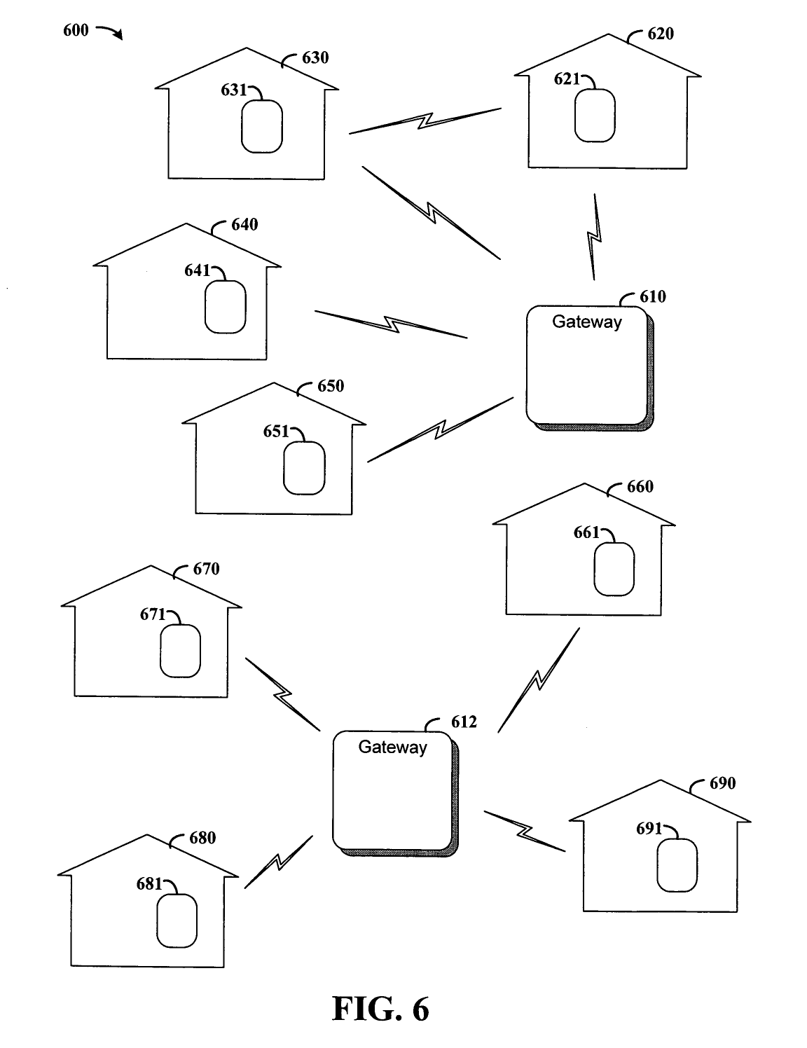

FIG. 6 is an energy control system 600 including local gateways and a plurality of locations with wireless thermostats having selective association with the local gateways, according to another example embodiment of the present invention. Gateways 610 and 612 are adapted to pass messages to wireless thermostats respectively assigned thereto, with wireless thermostats 621, 631, 641 and 651 being associated with gateway 610 and with wireless thermostats 661, 671, 681 and 691 being associated with gateway 612. The selective association is carried out, for example, using an approach similar to those discussed above and may include the assignment of network IDs that correspond to the thermostats served by a particular gateway.

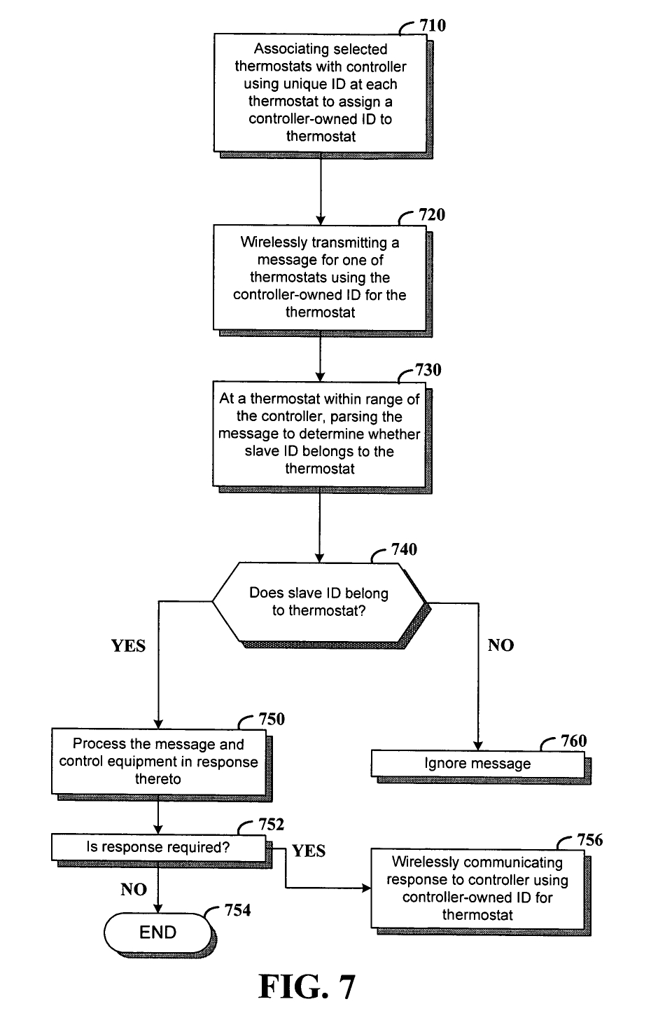

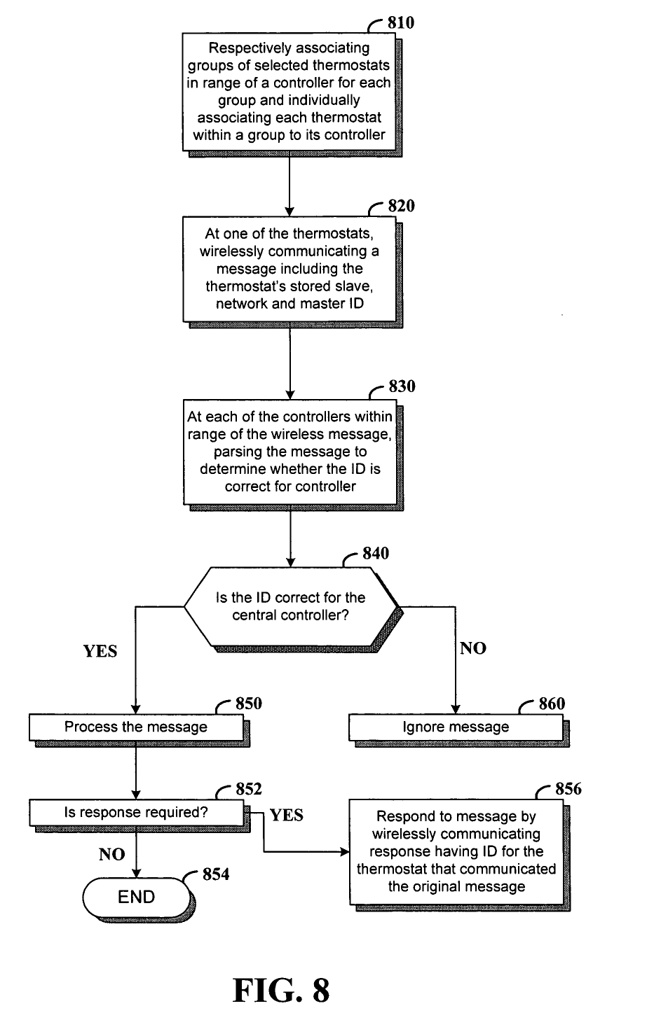

Each of the wireless thermostats 621-691 are coupled to HVAC type equipment at their respective locations 620-690 and are responsive to communications received via the respective gateway to which it is assigned. In addition, each of the wireless thermostats has a unique ID (e.g., network ID) that is used to discriminate between wireless messages sent from the gateways 610 and 612 and also used by the gateways to discriminate between wireless thermostats. For example, each of the wireless thermostats 621-651 is assigned an ID including a network and master ID associated with the gateway 610 and shared among the wireless thermostats, as well as a unique slave ID associated with the individual wireless thermostat. Similarly, each of wireless thermostats 661-691 is assigned an ID including a network ID and master ID associated with the gateway 612 and shared among the wireless thermostats. When parsing wireless messages, the gateway 610 (and correspondingly gateway 612) need only identify the network ID and master ID portion of the ID included with the wireless messages that belongs to itself. Example approaches for association and communication between the wireless thermostats and gateways discussed below in connection with FIGS. 7 and 8 can be implemented in connection with the energy control system 600.

Optionally, one or more of the wireless thermostats shown in FIG. 6 is adapted to communicate directly with another wireless thermostat, for example to relay information received from a gateway. For example, referring to wireless thermostats 621 and 631, communications received at the wireless thermostat 631 from the gateway 610 can optionally be relayed to the wireless thermostat 621. In addition, information can optionally be stored and forwarded at one or more of the gateways and thermostats. With these approaches, the range of the gateway 610 and/or the thermostats can be extended. In addition, this approach may be useful for increasing the reliability of wireless communications by reducing the distance that the wireless communications have to travel.

FIG. 7 is a flow diagram showing a method for communicating between a controller and a thermostat in an environment with multiple controllers and multiple thermostats, according to another example embodiment of the present invention. As mentioned above, the approach discussed here in connection with FIG. 7 may be applicable to the system 600 shown in FIG. 6. At block 710, a controller-owned association ID including slave, network and master ID data is assigned to a thermostat to associate the thermostat with a particular controller. The association is achieved, for example, using a unique ID for the thermostat to request assocation with a central contoller, which responds by sending the controller-owned association ID to the thermostat (e.g., as discussed in various example embodiments above). Controller ownership of the association ID enables the thermostat to be replaced and the replacement thermostat to be assigned the same controller-owned association ID, providing for a flexible, upgradable system.

At block 720, a message is wirelessly transmitted from the controller using the controller-owned association ID to identify the thermostat for which the message is intended. At block 730, one of the thermostats within range of the controller parses the message to determine whether the slave ID portion of the message belongs to the thermostat. In one implementation, the controller broadcasts data for all thermostats associated with it, with each thermostat determining, at block 730, whether the network ID and master ID are correct for the controller to which it is associated.

If the slave ID does not belong to the thermostat at block 740, the message is ignored at block 760. If the slave ID does belong to the thermostat at block 740, the control data is processed at block 750 and equipment is controlled in response thereto, for example, by setting a characteristic of the thermostat or by otherwise directly controlling equipment to which the thermostat is coupled. If a response by the thermostat to the controller is required at block 752 e.g., to acknowlege receipt of the data or to show compliance with the data, such as in an energy-reduction scenerio), such a response is wirelessly communicated to the controller at block 756. The response message includes the controller-owned association ID for the thermostat, which is parsed by the controller and used to recognize the source of the response. This approach is useful, for example, where compliance of the thermostat with utility directives (e.g., power consumption) is desirably monitored; a response message identifying the thermostat and compliance condition is thus used to monitor compliance. If no response is necessary at block 752, the process ends at block 754.

FIG. 8 is a flow diagram showing a method for communicating from a thermostat to a controller in an environment with multiple controllers and multiple thermostats, according to another example embodiment of the present invention. As mentioned above, the approach discussed here in connection with FIG. 8 may be applicable to the energy control system 600 shown in FIG. 6. At block 810, groups of selected thermostats are respectively associated with controllers in the environment, each thermostat being individually associated with its controller using, e.g., a controller-owned slave, network and master ID. The network and master IDs are optionally shared among more than one thermostat, with each thermostat being assigned a unique slave ID. At block 820, one of the thermostats wirelessly communicates a message including the thermostat's stored controller-owned ID information. At block 830, each of the controllers within range of the message parses the message to determine whether the message emanates from a thermostat belonging to it. Specifically, each controller detects whether at least one of the network and master ID portions of the controller-owned ID information belong to the controller, and whether the slave ID is valid. If there is only one controller per network ID, finding a matching network ID alone at block 830 may be sufficient to determine that the message is intended for the controller. Determining whether the slave ID is valid may involve, for example, directly corresponding the slave ID to stored slave IDs at the controller or using a range identification approach by identifying that the slave ID is within a range of slave IDs assigned to the controller.

If the parsed message does not include a correct ID for the controller at block 840, the message is ignored at block 860. If the ID is correct at block 840, the controller processes the message at block 850. If a response to the message is required at block 852, a response is wirelessly communicated at block 856 using the controller-owned ID information to specify the thermostat sending the original message as the intended recipient of the response. If a response to the message is not required at block 852, the process ends at block 854.

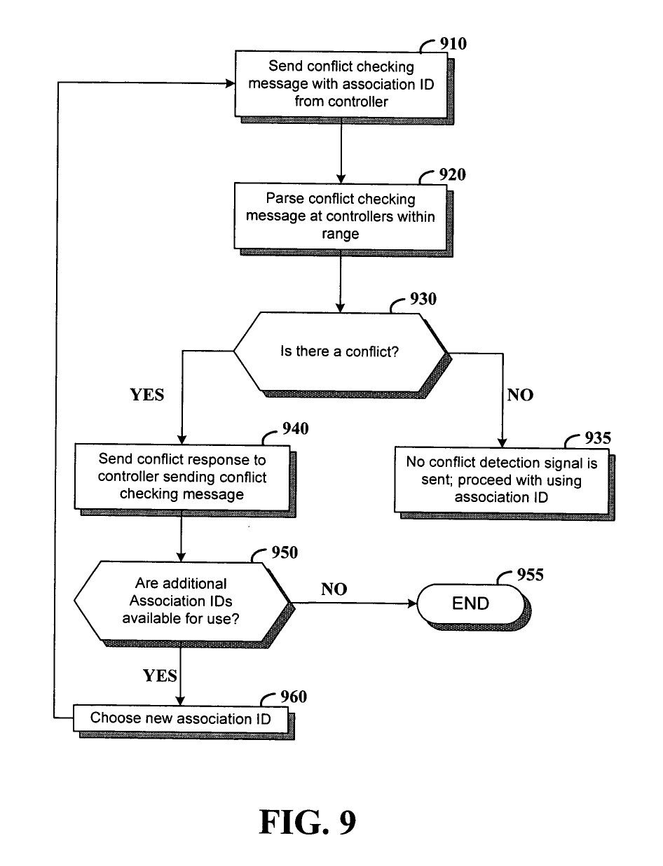

FIG. 9 shows an approach for ID conflict checking in an environment with multiple controllers and wireless nodes, according to another example embodiment. At block 910, a conflict checking message is sent from a controller wishing to establish an association ID. The association ID (or a portion thereof, such as a network ID portion) is included with the conflict checking message. At block 920, other controllers (and/or relaying thermostats) within range parse the conflict checking message. If a portion of the association ID is in use at block 930 at one of the controllers, a conflict is detected at the controller and a conflict response is sent at block 940. In response, the controller sending the conflict checking message checks to see if additional association IDs are available at block 950. If an association ID is available, a new association ID that does not include the conflicting portion is chosen at block 960. The process then resumes at block 910 with the new association ID. If no association ID is available at block 950, the process ends at block 955. If no conflict is detected at block 930, the conflict checking process ends at block 935, with the controller proceeding to use the association ID.

The above-discussed approaches can be implemented in various stages and combinations to address a variety of implementations. The following specific example embodiment involves the use of network, slave and master ID information used in an association ID, as well as IDs specific to a wireless node (RF_device_id) and controller (RF_peripheral_id), and employs some of the approaches discussed above and shown in the figures. Reference to hosts below refer, for example, to a processor using a particular RF communications device (RF device or RF peripheral), with both the processor and RF communications device being located at a wireless node or controller, depending upon the implementation. Each of the IDs (peripheral, network, master, device and slave) are established as follows in one particular embodiment, with RF peripheral referring to an RF module located at a controller and RF device referring to an RF module located at a wireless node such as a thermostat:
RF_peripheral_id: The RF peripheral ID is 4-bytes, has a value from memory of a RF peripheral processor that is determined during manufacturing and belongs to the RF peripheral. This value is formatted as YYWWNNNN where: YY is the year of manufacture specially formatted to be viewed as a decimal number when displayed as a hexadecimal number in the range 00-99. WW is the week in the year of manufacture specially formatted to be viewed as a decimal number when displayed as a hexadecimal number (01-53). NNNN is a sequential number of the peripheral among peripherals manufactured in the manufacturing week WW.
network_id: The network ID is 2-bytes, has a value that is unique within the RF range of the controller to identify a logical network and belongs to the RF peripheral. The initial value is set equal to the upper two bytes (YYWW) of the RF peripheral's RF_peripheral_id. A controller may optionally assign this value before binding (e.g., when replacing an existing controller as discussed above). A binding protocol used for establishing association between the controller and wireless nodes allows no duplication within the RF coverage range of the controller. Alternate values are optionally provided to eliminate duplication, or the RF peripheral itself is optionally exchanged to avoid duplication. This value is stored in the memory of a controller host for refreshing the RF peripheral, and also stored in the memory of a host (e.g., thermostat) for refreshing an RF device at the wireless node.
master_id: The master ID is 1-byte, has a value selected by the RF peripheral and belongs to the RF peripheral. This value is stored in a controller host's memory for refreshing the RF peripheral. Optionally, the controller host assigns this value before binding (e.g., upon replacement of an existing controller/RF peripheral as discussed above). The value is also stored in the wireless node's host memory for refreshing the RF device.
RF_device_id: The RF device ID is 4-bytes, has a value from memory of a RF device processor that is determined during manufacturing and belongs to the RF device. This value is formatted as YYWWNNNN where: YY is the year of manufacture specially formatted to be viewed as a decimal number when displayed as a hexadecimal number and has a range of 00-99. WW is the week in the year of manufacture specially formatted to be viewed as a decimal number when displayed as a hexadecimal number (01-53). NNNN is a sequential number of the RF device among devices manufactured in the manufacturing week WW. The value may be stored in a network server database to provide a means of identifying a particular RF device, which is also useful for replacing the RF device.
slave_id: The slave ID is 1-byte, has value derived algorithmically by the RF peripheral and belongs to the RF device. All bound (associated) slave_id values, or the contiguous range of such values, is stored in the controller host's (in RF peripheral) memory for refreshing RF peripherals. Individual values are stored in the wireless node's memory for refreshing RF devices on reset.

An RF peripheral host's non-volatile storage requirements are network_id, master_id, and the valid slave_id value for last RF device logically bound to the RF peripheral. If no RF devices are bound to a RF peripheral, the slave_id value equals the master_id value. A RF device host's non-volatile storage requirements are network_id, master_id, and the RF device's slave_id. The network, master and slave ID values correspondingly make up an association or binding ID value, for instance as referenced in connection with other example embodiments and implementations herein.

A wireless node host (with the RF device) initiates a message transaction by instructing an RF device to transmit a command message to its bound RF peripheral. When an RF peripheral receives a correct message with proper network_id and master_id and a valid slave_id it immediately acknowledges the message. Assuming valid addressing, the RF peripheral passes the message to a controller host that processes the received message, a response is determined, and the controller host directs the RF peripheral to transmit the response.

When a RF device receives a correct response message with the proper network_id, master_id, and slave_id it acknowledges the message immediately. The RF device then buffers the received message and waits for its host to retrieve the buffered message. If the network_id, master_id, or slave_id are incorrect, the RF peripheral or RF device provides no acknowledgment response and continues listening or times out.

At power-up and/or on reset a RF device places its RF transceiver in sleep mode, prepares a buffer indicating an unbound condition and places its micro-controller (processor) in sleep mode but prepared to wake on association activity initiated by the RF device host (e.g., wireless node or thermostat host).

At power-up and/or on reset a RF peripheral places its RF transceiver in receive mode, loads its network_id with its RF_peripheral_id MSB's (most significant byte's) value, loads its master_id and slave_id with 0 and sends a reset event to a controller host. An RF peripheral device does not enter sleep mode in instances, for example, where its RF transceiver is either receiving or transmitting and is always active.

An example binding approach involving the above-discussed peripheral, network, master, slave and device IDs is as follows. An unbound RF peripheral is initialized by selecting its RF_peripheral_id MSB's from its program memory as the initial network_id. The master_id and slave_id are initially assigned a value of 0. Before binding (and optionally periodically), a controller host directs the RF peripheral to test the proposed or current network_id by transmitting a conflict checking request addressed as a network_id broadcast with master_id and slave_id equal to 0. Any RF peripheral receiving such a conflict-checking message on its network_id responds by transmitting a similar conflict checking response message. Any RF peripheral receiving such a conflict-checking message with a matching network_id sends a network conflict event to its host. If an unbound controller host receives a network conflict event the host proposes a new network_id. This process continues until an available network_id is determined. If an already bound controller host application receives too many network conflict events in too short of a time period it may choose to report the network_id conflict, e.g., to a utility company in the event the approach is used with energy consumption. In addition, if a free network_id cannot be found, an error occurs and the RF peripheral cannot join the network (e.g., if a rogue RF peripheral sends back a conflict checking response message to every conflict check request). This error can be similarly reported.

The binding process begins when binding is initiated at both the controller and the wireless node (e.g., thermostat). After initiation, the controller is placed in binding mode. The controller waits up to 5 minutes for an RF device to send a binding command. The binding command data includes the 4-byte RF_device_id beginning in the network_id field and extending through the slave_id field in the command data. The binding command is globally broadcast with the slave's source address composed of the 2 MSB's of the RF_device_id and the least significant byte (LSB) of the RF_device_id.

In response to a binding command, the RF peripheral transmits network_id, master_id and the next unused slave_id data to the RF device. For instance, a master_id is first selected as 1, with slave_id values ranging from 2 through 127 inclusive are assigned that begin sequentially following the master_id value. Zero and values 128 through 255 inclusive are invalid values for master_id and slave_id. For this binding message response the destination address is the 2 MSB's of the RF_device_id followed by the LSB of the RF_device_id and the source address is the global broadcast address. The RF peripheral also sends a binding event to the controller host and exits the BIND mode.

The RF device forwards the network_id, master_id, and slave_id data to its host for storage in non-volatile memory (e.g., to a processor and memory, such as a thermostat coupled to the RF device). Once bound, the RF peripheral and RF device enter normal operating mode as instructed, for example, at respective user interfaces at the RF peripheral and RF device.

The foregoing description of various example embodiments of the invention has been presented for the purposes of illustration and description. It is not intended to be exhaustive or to limit the invention to the precise form disclosed. Many modifications and variations are possible in light of the above teaching. For example, a wireless controller for a multitude of energy-consuming appliances can be used in place of the controllers described herein (e.g., in place of the HVAC controllers). As another example, the controllers or gateways discussed herein may include multiple devices and devices at different locations. For instance, the gateways may include the functionality of a local utility company as discussed above. In addition, reference to a controller may include both a wireless communications device and a processing device coupled thereto. As still another example, one of the wireless nodes or thermostats may also function as a controller or gateway, effectively communicating with other wireless nodes/thermostats as a controller/gateway. In the instance where a utility company or other outside source is involved, the wireless node/thermostat functioning as a controller/gateway also communicates directly with the outside source. It is intended that the scope of the invention be limited not with this detailed description, but rather by the claims appended hereto.

1. A method for wireless association between a controller and a wireless node, the method comprising:
transmitting association request data from the wireless node, the association request data including unique identification (ID) data for the wireless node;
receiving the association request data at the controller and, in response, sending association ID data assigned to the wireless node by the controller using the unique ID with the association ID data to identify the wireless node as the intended recipient of the association ID data, the controller storing the association ID data for use in sending wireless signals to the wireless node; and
receiving and storing the association ID data at the wireless node as a function of the unique ID, thereby associating the wireless node with the controller.

2. The method of claim 1, further comprising:
using the stored association ID data at the wireless node to identify incoming wireless signals from the controller as signals intended for the wireless node.

3. The method of claim 1, further comprising:
using the association ID data at the controller to identify incoming wireless signals sent from the wireless node as coming from the wireless node.

4. The method of claim 1, wherein assigning association ID data includes assigning network ID data corresponding to a network of wireless nodes served by the controller.

5. The method of claim 4, further comprising selecting the network ID data by parsing network ID data in use within range of the controller and selecting network ID data that is not in use within range.

6. The method of claim 1, wherein assigning association ID data includes assigning slave ID data that is exclusively assigned to the wireless node among wireless nodes within a network of wireless nodes.

7. The method of claim 1, wherein assigning association ID data includes assigning master ID data that is exclusive to the controller relative to controllers within communication range of the wireless node.

8. The method of claim 7, after assigning association ID data, further comprising replacing the controller with a new controller, storing the association ID data at the new controller and using the master ID data to identify the new controller.

9. The method of claim 1, prior to transmitting association request data, further comprising inputting an association request at the wireless node and wherein transmitting association request data includes transmitting the association request data in response to the association request input.

10. The method of claim 9, further comprising entering an association mode at the wireless node for a selected time period and exiting the association mode after the selected time period has expired, wherein receiving and storing the association ID data at the wireless node includes receiving and storing the association ID data if the wireless node is in the association mode.

11. The method of claim 9, further comprising inputting an association request input at the controller and wherein sending association ID data includes sending the association ID data in response to both the association request input at the controller and the received association request data.

12. The method of claim 11, further comprising entering an association mode at the controller for a selected time period and exiting the association mode after the selected time period has expired, wherein receiving the association request data at the controller and, in response, sending association ID data includes sending association ID data if the controller is in the association mode.

13. The method of claim 1, after receiving and storing the association ID data at the wireless node, replacing the wireless node with a new wireless node by storing the association ID data at the new wireless node.

14. The method of claim 1, further comprising sending messages to the wireless node using the association ID data to identify the wireless node as the intended recipient of the messages and using the messages at the wireless node to control equipment coupled thereto.

15. The method of claim 1, prior to sending association ID data, further comprising:
sending a conflict checking message including a network ID to be used with the association ID;
in response to receiving a network ID conflict response of another controller to the conflict checking message, selecting a new network ID to be included with the association ID and re-sending a conflict checking message; and
in response to not receiving a network ID conflict response, sending the association ID data.

16. The method of claim 1, further comprising:
using the controller to monitor wireless conflict checking messages from other controllers within range of the controller; and
in response to receiving a conflict checking message including a network ID that is in use by the controller, sending a conflict response.

17. A method for wirelessly communicating between a controller and a wireless node, the method comprising:
transmitting association request data from the wireless node, the association request data including a unique device ID for the wireless node;
receiving the association request data at the controller and, in response, sending an association ID assigned to the wireless node by the controller using the unique device ID with the association ID to identify the wireless node as the intended recipient of the association ID, the controller storing the association ID for use in sending wireless messages to the wireless node;
receiving and storing the association ID data at the wireless node as a function of the unique ID;
using the stored association ID data at the wireless node to identify incoming wireless messages from the controller as messages intended for the wireless node; and
using the association ID data at the controller to identify incoming wireless messages sent from the wireless node.

18. The method of claim 17, wherein storing association ID data at the controller includes storing range limits for association IDs of wireless nodes assigned to the controller, and wherein identifying messages sent from the wireless node to the controller with the association ID data includes determining whether the association ID data is within the stored range limits.

19. The method of claim 18, further comprising:
in response to the association ID data being within a predetermined range, processing the association ID data at the controller; and
in response to the association ID data being outside of the predetermined range, ignoring the association ID data at the controller.

20. The method of claim 17, wherein assigning association ID data includes assigning network ID data corresponding to a network of wireless nodes served by the controller and wherein using the association ID data at the controller to identify incoming wireless messages sent from the wireless node includes determining, at the controller, that the network ID data corresponds to a network served by the controller.

21. The method of claim 17, wherein assigning association ID data includes assigning master ID data that is exclusive to the controller relative to controllers within communication range of the wireless node and wherein using the association ID data at the controller to identify incoming wireless messages sent from the wireless node includes determining, at the controller, that the master ID data corresponds to the controller's master ID data.

22. The method of claim 17, wherein using the stored association ID data at the wireless node to identify incoming wireless messages includes identifying the incoming wireless messages from a plurality of incoming wireless messages traversing shared media that is susceptible to the transmission of multiple wireless messages.

23. A method for controlling a plurality of wireless thermostats in communication range with at least one gateway, each wireless thermostat coupled to control HVAC type equipment, the method comprising:
transmitting association request data from a wireless thermostat, the association request data including unique identification (ID) data for the wireless thermostat;
receiving the association request data at the gateway and, in response, sending gateway-owned association ID data assigned to the wireless thermostat by the gateway using the unique ID to identify the wireless thermostat as the intended recipient of the association ID, the gateway storing the association ID data for use in sending wireless messages to the wireless thermostat and to identify incoming wireless messages sent from the wireless thermostat;
receiving and storing the gateway-owned association ID data at the wireless thermostat as a function of the unique ID to identify incoming wireless messages from the gateway as messages intended for the wireless thermostat;
communicating control messages from the gateway to the wireless thermostat using the association ID data to identify the wireless thermostat as the intended recipient of the control messages; and
at the wireless thermostat, accepting the control messages as function of the association ID data and, in response to the control messages, controlling HVAC equipment coupled to the wireless thermostat.

24. The method of claim 23, further comprising using the association ID to label compliance data sent from the wireless thermostat to identify the source of the compliance data, the compliance data being indicative of user compliance with the utility control messages.

25. The method of claim 24, further comprising sending the compliance data from the gateway to a local utility provider.

26. The method of claim 23, wherein communicating control messages from the gateway includes communicating control messages in response to control messages received at the gateway from a local utility company.

27. The method of claim 23, wherein communicating control messages from the gateway includes broadcasting information from the gateway to a plurality of wireless thermostats using a network ID included with the association ID, each of the plurality of wireless thermostats being adapted to receive the broadcast information as a function of the network ID portion of the association ID.

28. The method of claim 27, wherein each wireless thermostat is adapted to respond to the broadcast information as a function of user inputs received at the wireless thermostat and to report a condition of the response to the gateway using the association ID to identify the wireless thermostat from which the reported condition was sent.

29. A system for wireless association between a controller and a wireless node, the system comprising:
means for transmitting association request data from the wireless node, the association request data including unique identification (ID) data for the wireless node;
means for receiving the association request data at the controller and, in response, for sending association ID data assigned to the wireless node by the controller using the unique ID with the association ID data to identify the wireless node as the intended recipient of the association ID data, the controller storing the association ID data for use in sending wireless signals to the wireless node; and
means for receiving and storing the association ID data at the wireless node as a function of the unique ID, thereby associating the wireless node with the controller.

30. A system for wireless communication, the system comprising:
a controller;
a wireless node;
the wireless node being configured and arranged for transmitting association request data including unique identification (ID) data for the wireless node;
the controller being configured and arranged for receiving the association request data and, in response, for sending association ID data assigned to the wireless node by the controller using the unique ID with the association ID data to identify the wireless node as the intended recipient of the association ID data, the controller storing the association ID data for use in sending wireless signals to the wireless node; and
the wireless node being configured and arranged for receiving and storing the association ID data as a function of the unique ID, thereby associating the wireless node with the controller.

31. The system of claim 30, wherein the wireless node is configured and arranged to use the stored association ID data at the wireless node to identify incoming wireless signals from the controller as signals intended for the wireless node.

32. The system of claim 30, wherein the controller is configured and arranged to use the association ID to identify incoming wireless signals sent from the wireless node as coming from the wireless node.

33. The system of claim 30, wherein the controller is configured and arranged to:
prior to sending association ID data, send a conflict checking message including a network ID to be used with the association ID;
in response to receiving a network ID conflict response of another controller to the conflict checking message, select a new network ID to be included with the association ID and re-send a conflict checking message; and
in response to not receiving a network ID conflict response, send the association ID data.
